(19) United States
(12) Patent Application Publication
(10) Pub. No.: US 2024/0338714 A1
(43) Pub. Date: Oct. 10, 2024

(54) SYSTEMS AND METHODS FOR EVALUATING HISTORICAL REAL ESTATE PRICE TRENDS

(71) Applicants: Naphtali David Rishe, Miami, FL (US); Malek Adjouadi, Miami, FL (US)

(72) Inventors: Naphtali David Rishe, Miami, FL (US); Malek Adjouadi, Miami, FL (US)

(73) Assignee: The Florida International University Board of Trustees, Miami, FL (US)

(21) Appl. No.: 18/296,568

(22) Filed: Apr. 6, 2023

(51) Int. Cl. G06Q 30/0202; G06Q 50/16

(52) U.S. Cl. CPC G06Q 30/0202; G06Q 50/163

(57) ABSTRACT

Systems and methods for evaluating historical trends in real estate prices are provided. Systems and methods provide an understanding of historical price trends and assist in a property evaluation or appraisal, as well as allowing for an analysis of comparables in estimating a reasonable offer for a property on the market. Given a timespan of interest, a locale, and a category of properties of interest, an objective historical trend in values can be computed by first evaluating the ratios between the realized prices of transactions and objective governmental assessment of the properties at some fixed point of time. Then, for each period the ratios of all transactions in that period can be averaged, followed by comparing said averages between different time periods.

### GOVERNMENT SUPPORT

This invention was made with government support under CNS2018611 and CNS1920182 awarded by the National Science Foundation. The government has certain rights in the invention.

### BACKGROUND

Various services and methods exist for the estimation of the change over time in real estate prices in any given locale. These prior models typically compute the average or median sale price in the locale during each period and then compare said statistics between the various periods. Some models can compare based on property categories, but in the prior models there is an “apples to oranges” comparison. Even in a small locale (e.g., a single zip code), and even in a narrow category, there are vastly different properties being averaged. This creates a statistical bias when different periods are compared because in one time period a certain type of property (e.g., quality-built properties with a view) may dominate while in another time period another type of property (e.g., lower quality properties) may dominate. This bias becomes even stronger when larger areas are analyzed (e.g., at the county or state level) because demographic changes can favor sale activity more in cheaper subareas in one time period and in more exclusive subareas in another time period.

### BRIEF SUMMARY

Embodiments of the subject invention provide novel and advantageous systems and methods for evaluating historical trends in real estate prices so that prices across time can be compared. This allows for an understanding of historical price trends and assists in a property evaluation or appraisal, as well as allowing for an analysis of comparables in estimating a reasonable offer for a property on the market. Given a timespan of interest, a locale, and a category of properties of interest, an objective historical trend in values can be computed by first evaluating the ratios between the realized prices of transactions and objective governmental assessment of the properties at some fixed point of time. Then, for each period the ratios of all transactions in that period can be averaged, followed by comparing said averages between different time periods.

In an embodiment, a system for evaluating a historical trend in real estate prices can comprise a processor and a machine-readable medium in operable communication with the processor and having instructions stored thereon that, when executed by the processor, perform the following steps: receiving first real estate data comprising a geographic locale, a category of real estate properties, and a timespan; receiving second real estate data comprising price information for each real estate transaction of a plurality of real estate transactions in the geographic locale, in the category of real estate properties, and in the timespan, the second real estate data comprising a sale price for each real estate transaction of the plurality of real estate transactions; receiving objective valuation data for each property of the plurality of real estate transactions, the objective valuation data comprising an objective valuation at a fixed valuation date for each property of the plurality of real estate transactions, the objective valuation being from a third-party source that was not involved (e.g., not a seller, a buyer, a property appraiser utilized in the transaction, an agent of the seller or the buyer, an employee of the seller or the buyer, or someone contracted by the seller or the buyer) in any real estate transaction of the plurality of real estate transactions; computing a ratio, for each real estate transaction of the plurality of real estate transactions, of the respective sale price to the respective objective valuation; partitioning the timespan into a plurality of time periods (each time period of the plurality of time periods can optionally be the same as each other time period of the plurality of time periods, though this is not necessary); and applying a statistical aggregation function on each time period, comprising applying the statistical aggregation function on all ratios within the respective time period to provide the historical trend of real estate prices relative to the objective valuation data. The geographic locale can be, for example, a zip code, a neighborhood, a town, a city, a county, a metropolitan area, or a state. The category of real estate properties can be, for example, single-family dwellings, condominium apartments, multiple-family dwellings, houses of a predetermined size range, commercial real estate (e.g. of a predetermined size range), or vacant land. The statistical aggregation function can be, for example, a median or a mean. Each time period of the plurality of time periods can be, for example, a month, a quarter, or a year. The fixed valuation date for each property of the plurality of real estate transactions can be, for example, a specific date on which a governmental entity (e.g., a local governmental authority) publishes its assessment valuation(s) (e.g., for the entire geographic locale). The instructions when executed can further perform the following step: removing any outliers from the plurality of real estate transactions before applying the statistical aggregation function. A real estate transaction can be considered an outlier if a characteristic of the real estate transaction is outside a predetermined range compared to the remaining real estate transaction of the plurality of real estate transaction (e.g., based on the ratio, property improvement dates, and/or irregular transaction types (e.g., foreclosure, short sale)). The system can further comprise a display in operable communication with the processor. The instructions when executed can further perform the following steps: providing a first plot of the historical trend of real estate prices relative to the objective valuation over the timespan; and displaying the first plot on the display. The instructions when executed can further perform the following steps: computing a percentage difference of the statistical aggregation function for each time period compared to the statistical aggregation function of all time periods of the timespan; providing a second plot of the percentage difference for each time period over the timespan; and displaying the second plot on the display. The instructions when executed can further perform the following steps: partitioning the geographic locale into a plurality of sub-locales (e.g., to create a hierarchy of locales, thereby enabling the comparison of a locale to its neighbors as well as to the geographic locales contained therein); applying the statistical aggregation function independently on each sub-locale of the plurality of sub-locales; and comparing a result of applying the statistical aggregation function for a first sub-locale of the plurality of sub-locales to that of a second sub-locale of the plurality of sub-locales. The third-party source that was not involved in any real estate transaction of the plurality of real estate transactions can be, for example, a governmental entity. The objective valuation can be, for example, “Just Value” as provided by certain counties in the state of Florida.

In another embodiment, a method for evaluating a historical trend in real estate prices can comprise: receiving (e.g., by a processor) first real estate data comprising a geographic locale, a category of real estate properties, and a timespan; receiving (e.g., by the processor) second real estate data comprising price information for each real estate transaction of a plurality of real estate transactions in the geographic locale, in the category of real estate properties, and in the timespan, the second real estate data comprising a sale price for each real estate transaction of the plurality of real estate transactions; receiving (e.g., by the processor) objective valuation data for each property of the plurality of real estate transactions, the objective valuation data comprising an objective valuation at a fixed valuation date for each property of the plurality of real estate transactions, the objective valuation being from a third-party source that was not involved in any real estate transaction of the plurality of real estate transactions; computing (e.g., by the processor) a ratio, for each real estate transaction of the plurality of real estate transactions, of the respective sale price to the respective objective valuation; partitioning (e.g., by the processor) the timespan into a plurality of time periods (each time period of the plurality of time periods can optionally be the same as each other time period of the plurality of time periods, though this is not necessary); and applying (e.g., by the processor) a statistical aggregation function on each time period, comprising applying the statistical aggregation function on all ratios within the respective time period to provide the historical trend of real estate prices relative to the objective valuation data. The geographic locale can be, for example, a zip code, a neighborhood, a town, a city, a county, a metropolitan area, or a state. The category of real estate properties can be, for example, single-family dwellings, condominium apartments, multiple-family dwellings, houses of a predetermined size range, commercial real estate (e.g. of a predetermined size range), or vacant land. The statistical aggregation function can be, for example, a median or a mean. Each time period of the plurality of time periods can be, for example, a month, a quarter, or a year. The fixed valuation date for each property of the plurality of real estate transactions can be, for example, a specific date on which a governmental entity (e.g., a local governmental authority) publishes its assessment valuation(s) (e.g., for the entire geographic locale). The method can further comprise removing (e.g., by the processor) any outliers from the plurality of real estate transactions before applying the statistical aggregation function. A real estate transaction can be considered an outlier if a characteristic of the real estate transaction is outside a predetermined range compared to the remaining real estate transaction of the plurality of real estate transaction (e.g., based on the ratio, property improvement dates, and/or irregular transaction types (e.g., foreclosure, short sale)). The method can further comprise: providing (e.g., by the processor) a first plot of the historical trend of real estate prices relative to the objective valuation over the timespan; and displaying (e.g., by the processor) the first plot (e.g., on a display, such as a display in operable communication with the processor). The method can further comprise: computing (e.g., by the processor) a percentage difference of the statistical aggregation function for each time period compared to the statistical aggregation function of all time periods of the timespan; providing (e.g., by the processor) a second plot of the percentage difference for each time period over the timespan; and displaying (e.g., by the processor) the second plot (e.g., on a display, such as a display in operable communication with the processor). The method can further comprise: partitioning (e.g., by the processor) the geographic locale into a plurality of sub-locales; applying (e.g., by the processor) the statistical aggregation function independently on each sub-locale of the plurality of sub-locales; and comparing (e.g., by the processor) a result of applying the statistical aggregation function for a first sub-locale of the plurality of sub-locales to that of a second sub-locale of the plurality of sub-locales.

### BRIEF DESCRIPTION OF DRAWINGS

FIG. 1 shows a table of property valuation by a county assessor.

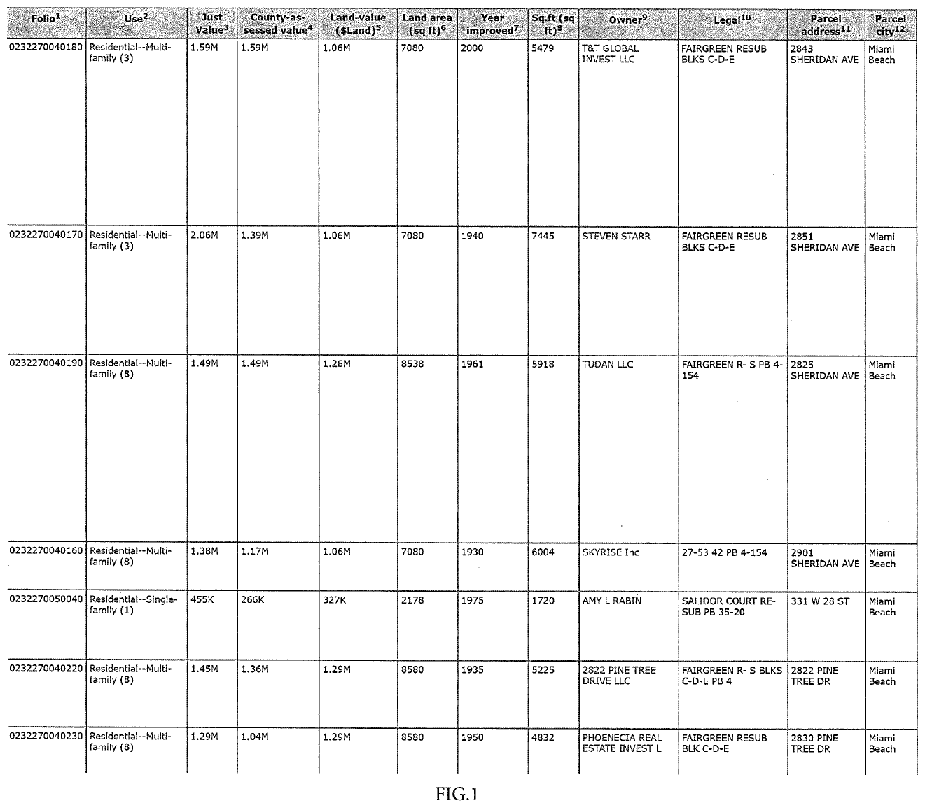

FIG. 2 shows metadata of various property valuations by county assessor offices in Florida in the United States of America. The “just value” is an objective valuation that can be used in embodiments of the subject invention.

FIG. 3 shows a table of ratios of realized price, at various times, to the county “just value” on Jan. 1, 2021. Row 3 has an obvious error ($0.246 per square foot as sold) and can be disregarded as an outlier.

FIG. 4 shows a listing of quantity of sales transactions in each month in 2006-2007 in zip code 33175, excluding outliers, and their respective averages of the ratio of the sale price to the fixed objective metric of the county valuation as of Jan. 1, 2021. Months with less than six transactions (e.g., September 2007) may be excluded.

FIG. 5 shows a listing of the normalization of the average ratios (the realized prices divided by the 2021 county valuation) to month 2006-02 (February 2006); i.e., dividing by the average ratio of 2006-02. The last column shows the percentage increase since 2006-02.

FIG. 6 shows a table of the normalization of the average ratios (the realized prices divided by the 2021 county valuation) of January 2022 through June 2022 to month 2006-02 (February 2006); i.e., dividing by the average ratio of 2006-02. The last column shows the percentage increase since 2006-02.

FIG. 7 shows a plot of percentage change in the average ratios (the realized prices divided by the 2021 county valuation) in comparison to February 2006, versus time, for houses in zip code 33175.

FIG. 8 shows two plots (for condos on top and for houses on bottom) of percentage change in the average ratios (the realized prices divided by the 2021 county valuation) in comparison to February 2006, versus time, for condos and houses in southeast Florida (SE FL). These plots use the closing dates as the reference time.

FIG. 9 shows a table of multiple listing services (MLS) data showing the contract pending data, in addition to the closing date, as well as the ratio of the closed sale price to the 2021 county valuation.

FIG. 10 shows two plots (for condos on top and for houses on bottom) of percentage change in the average ratios (the realized prices divided by the 2021 county valuation) in comparison to February 2006, versus time, for condos and houses in SE FL. These plots use the dates of purchase contracts rather than the closing dates as the reference time.

FIG. 11 shows a representation of partitioning of SE FL into a hierarchy of smaller locales.

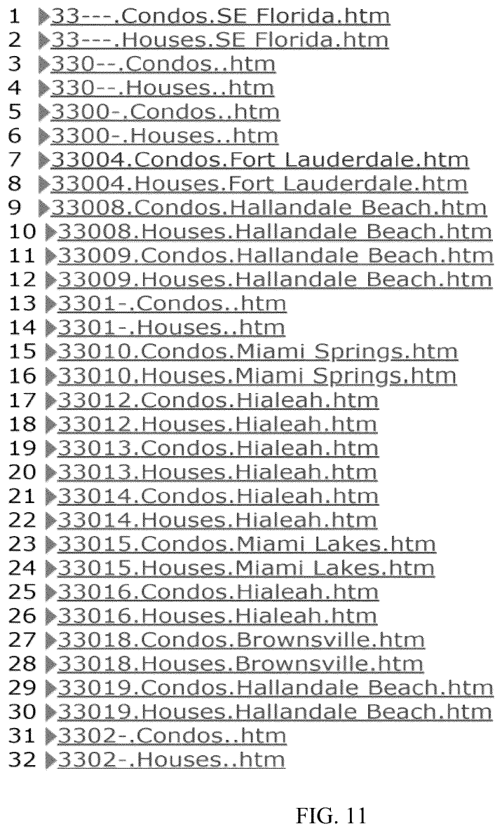

FIG. 12 shows pseudo code for an algorithm that can be used, according to an embodiment of the subject invention.

FIG. 13 shows pseudo code for an algorithm that can be used, according to an embodiment of the subject invention.

### DETAILED DESCRIPTION

Embodiments of the subject invention provide novel and advantageous systems and methods for objectivizing real estate prices and/or evaluating historical trends in real estate prices, so that prices across time can be compared. This allows for an understanding of historical price trends and assists in a property evaluation or appraisal, as well as allowing for an analysis of comparables in estimating a reasonable offer for a property on the market. Given a timespan of interest, a locale (e.g., a particular zip code, a city, a county, or a state), and a category of properties of interest (e.g., condos, single-family dwellings, or multi-family dwellings), an objective historical trend in values can be computed by first evaluating the ratios between the realized prices of transactions and objective governmental assessment of the properties at some fixed point of time. Then, for each period (e.g., a week, a month, a set number of months, or a year) the ratios of all transactions in that period can be averaged, followed by comparing said averages between different time periods.

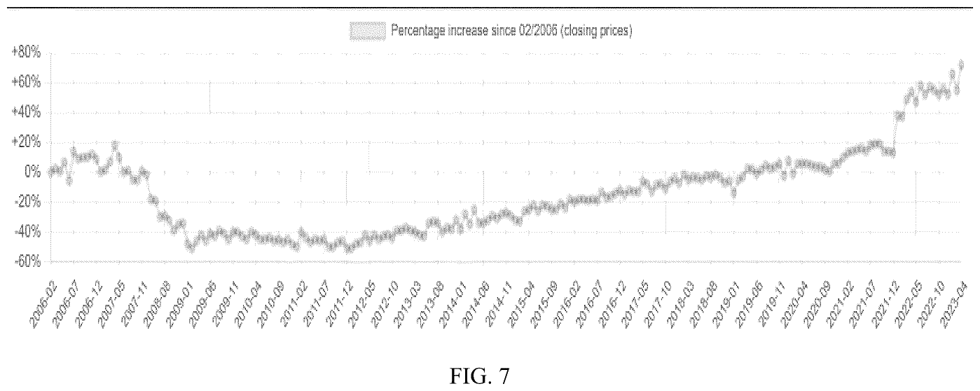

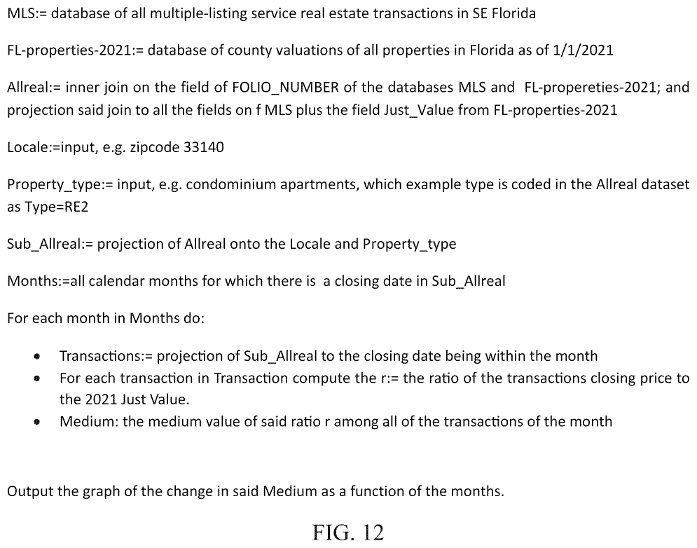

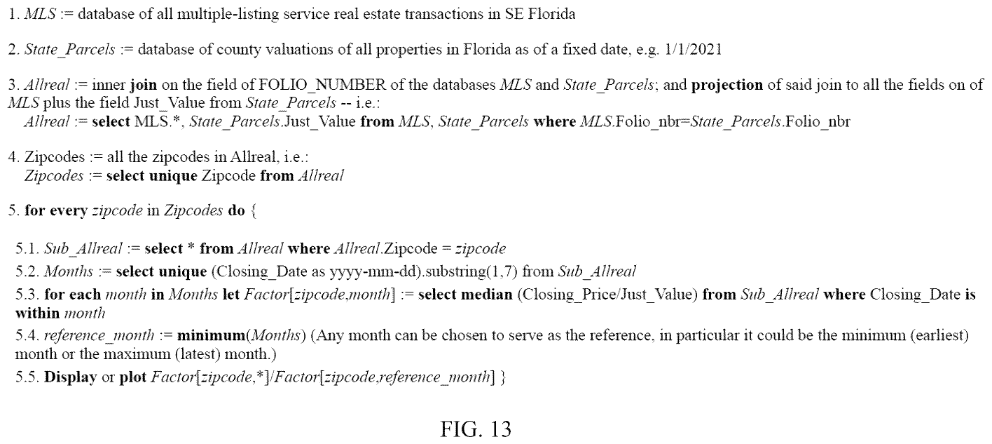

Systems and methods of embodiments of the subject invention evaluate historical real estate price trends. Input data to the system/method can include a geographic locale, the specification of a category of real estate properties, a timespan, and/or a set comprising a majority of purchase transactions of properties in said category (if applicable) during said timespan (if applicable) in said locale (if applicable), each of which transactions is associated with a date and the purchase price. The system/method can obtain an objective, authoritative property valuation dataset, which at a fixed approximate valuation date assigns valuation to each of a majority of real estate properties of said category (if applicable) in said locale (if applicable), which valuation has a mostly-consistent relationship to the true value of each real estate property in said locale as of said date. For each of said transactions, the system/method can compute the ratio between said price of the transaction and said valuation of the transacted property. The system/method can partition said timespan into time periods. The system/method can utilize a representative statistical aggregation function. For each of said time periods, the system/method can apply said aggregation function to the subset of said ratios that pertain to the transactions of said period. This can lead to a useful evaluation of historical real estate price trends (see also, e.g., FIGS. 7, 8, and 10). FIGS. 12 and 13 show pseudo code for an algorithm that can be used in certain embodiments of the subject invention.

The geographic locale(s) can be, for example, a zip code, a neighborhood, a zone, a town, a city, a county, a metropolitan area, or a state. The categories of real estate properties can be, for example, single-family homes, condominium apartments, homes of a given size range, or vacant land. The representative statistical aggregation function(s) can include, for example, a median or an average. The time periods can be, for example, months, quarters, or years. The date associated with the transaction can be, for example, the closing date or the purchase contract effective date.

In some embodiments, outlier cleansing can be performed on the input data (e.g., before computing the ratio or after computing the ratio), and such outlier cleansing can be based on, for example: the ratios; the ratios and the dates; and/or additional data, which may include property improvement dates and/or irregular transaction types (foreclosure, short sale).

In some embodiments, the medians or averages (or other statistical aggregation function) of each period can be normalized to the base period (e.g., by dividing the median (or other function) of each period by the median (or other function) of the base period).

In some embodiments, the percentage increase and/or decrease of the median (or other function) of each period versus that of the base period can be calculated.

In some embodiments, the historical real estate price trend(s) can be presented as a chart or graph, with one axis being the timeline (or time periods) and the other axis being the median (or other function) or normalized version thereof or percentage of increase/decrease of the median (or other function) since the base period.

In some embodiments, large locales can be partitioned into smaller locales, thereby creating a hierarchy of locales and enabling the comparison of a locale to its neighbor(s) as well as to its subsuming locale(s).

Related art models that compare price per unit of size (e.g., price per interior square foot of a home) comingle properties of different type and/or quality (e.g., residences with a view and residences without a view, well-built houses and poorly built houses). Also, accounting for only one size metric, such as interior area, ignores other size metrics, such as lot size. Embodiments of the subject invention use models that objectivize real estate prices so that prices across time can be compared to understand historical price trends and also to assist in property evaluation or appraisal, as well as for the analysis of comparables in estimating a reasonable offer for a property on the market.

In order to objectivize and normalize real estate transactions across a locale and across a time period, embodiments of the subject invention can utilize a metric of valuation of properties that is consistent among all the properties in the locale at some point time. Said point in time of the objective metric does not need to be within said time period. Further, said metric does not have to represent the true value of each property at said point in time; rather, it has to be consistently related and/or proportional to the true value. Said relationship does not have to be a precise linear proportion, nor does it have to be truly consistent in 100% of the cases because said metric is only necessary for a statistical aggregation of a large numbers of cases. One such metric could be property valuation by local government tax assessors (e.g., the tax appraisal offices in most counties in the United States of America). Local government tax assessors (e.g., tax appraisal offices in counties in the U.S.) typically invest immense effort to attempt consistent valuation of all the properties under their jurisdiction, taking into account quantitative metrics (e.g., the size of the interior, the size of the lot, the year built, the year renovated (if applicable), the ground elevation, the floor level elevation of a condo in a building, the costs of improvement made based on the permits filed (if applicable), etc.) and qualitative metrics (e.g., location, exposure, view, special features, etc.). For example, in Florida, the county assessor offices determine what they call the “just value” of the properties as of January 1 of the assessment year. In order to minimize litigation, the assessor's office typically sets the “just value” at 10-20% below the true value, which does not affect the model or algorithm of embodiments of the subject invention, as long as said discount is reasonably consistent.

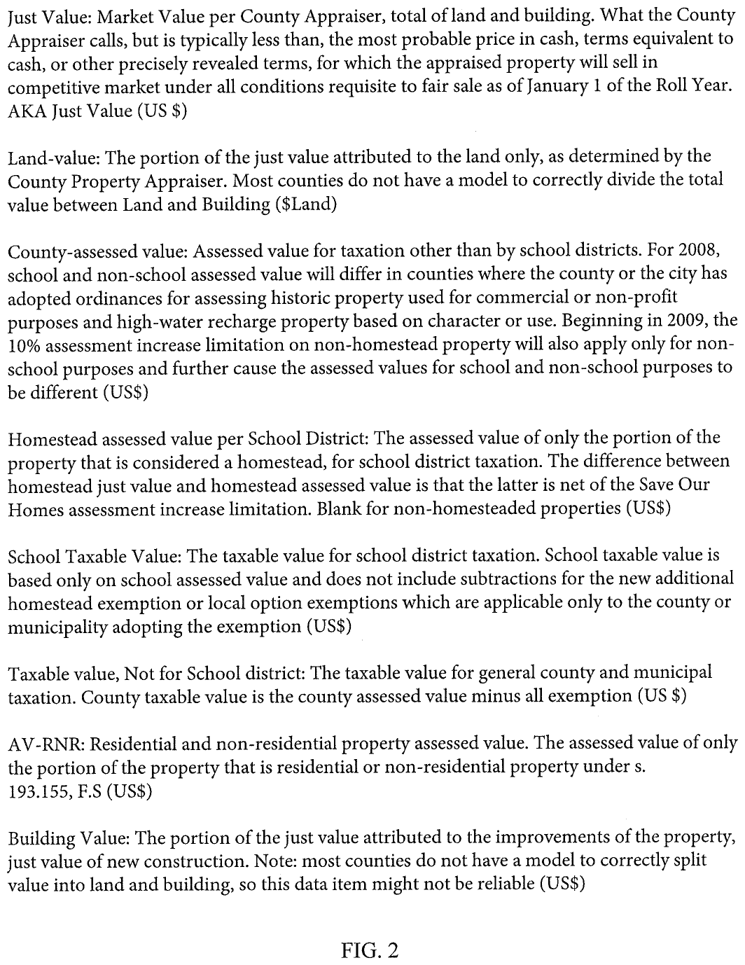

It should be noted that government offices sometimes provide multiple types of valuations for tax purposes. FIG. 2 shows a listing of some official “valuations” available from Florida counties. Among these valuations, the only meaningful one for purposes of objective valuation is the “Just Value.” The other valuations either reflect only a part of the property value (e.g., the Land Value or the Improvement Value) or are affected by the demographics of the property owner and, thus, are not meaningful for understanding the true value of the property.

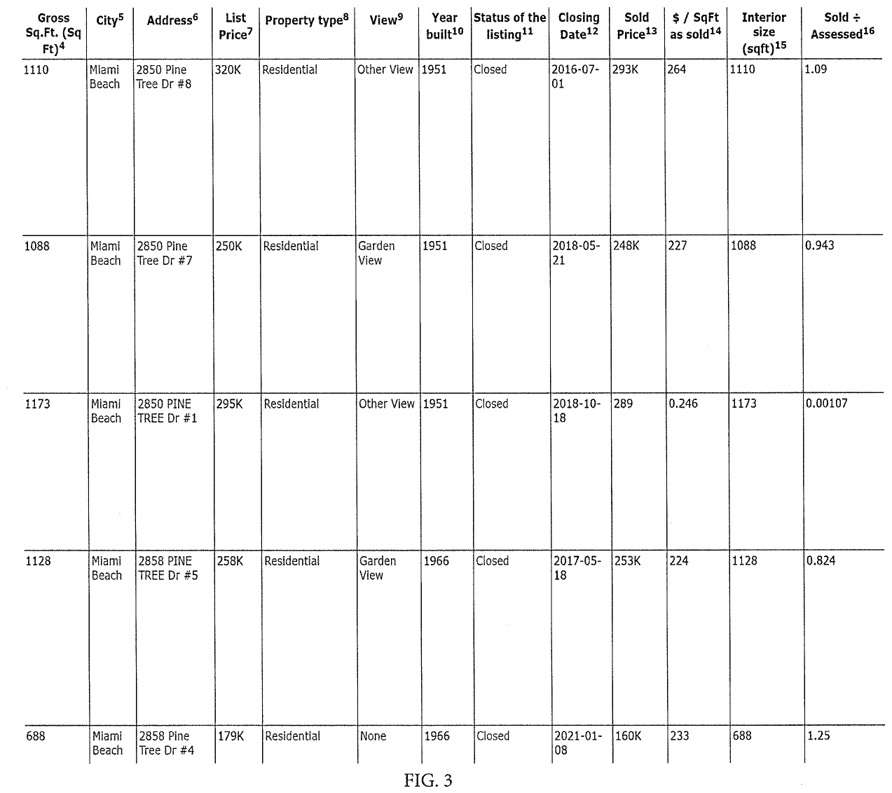

Systems and methods of embodiments of the subject invention can compare the transactional sale price of each property, no matter when, to a one time-fixed metric of an objective valuation, in order to evaluate the ratio by which the realized price is above (or below) said metric. That is, said ratio is the ratio between the realized price and said objective metric. In the example shown in FIG. 3, sales at different times are compared to the county's “Just Value” as of Jan. 1, 2021, to compute the ratio factor. It is noted that row 3 in the table of FIG. 3 contains an obvious data entry error. Therefore, there can be a data-cleansing process in order to disregard outliers that are outside a reasonable range. Data about the realized prices of each transaction can be obtained from databases (e.g., proprietary databases), such as those provided by data consolidators, from county or state records, or from the Real Estate Multiple Listing Service (MLS), as in FIG. 3.

The ratio thusly computed is an objective comparison metric between different sale transactions in a locale at close times or across long timespans. In order to better compare sale transactions over time within a locale, properties can be subdivided into categories because it is possible that in different property categories, prices increased at different paces. For example, two categories of properties can be considered: single-family homes vs. condominium apartments (this is for exemplary purposes only and should not be construed as limiting; any quantity and combination of categories can be considered).

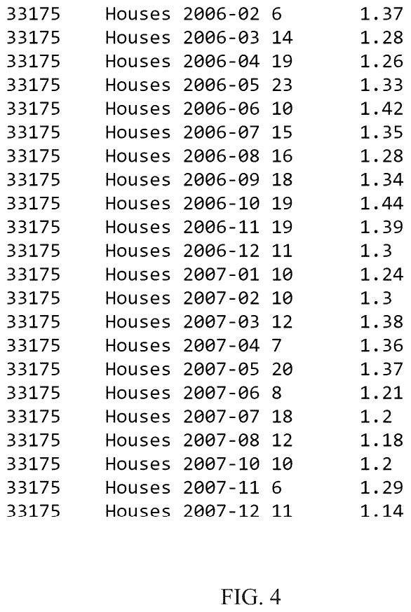

A locale of interest (e.g., zip code 33175) can be considered, as can a category of interest (e.g., single-family homes) and/or a timespan of interest (e.g., from Jan. 1, 2006, through Dec. 31, 2007). FIG. 4 shows a listing of such data as an example. Said timespan can be subdivided into periods (e.g., calendar months). In each period, for each sale transaction, the ratio of the price to the fixed objective metric (e.g., the 2021 County “Just Value”) can be evaluated. Outlier transactions can be excluded based on any criteria of outlier exclusion. For each period, a representative statistical aggregator of the ratios can be evaluated (e.g., the average of the ratios or the median of the ratios, of all the relevant sale transactions). Months with a very low number of transactions (e.g., less than 6) may be excluded to avoid the possibility of excess weight of any single transaction, which may cause bias in statistical analysis across time.

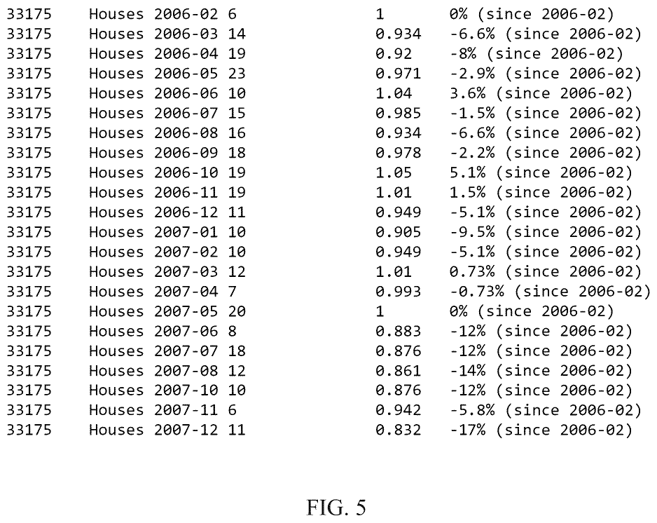

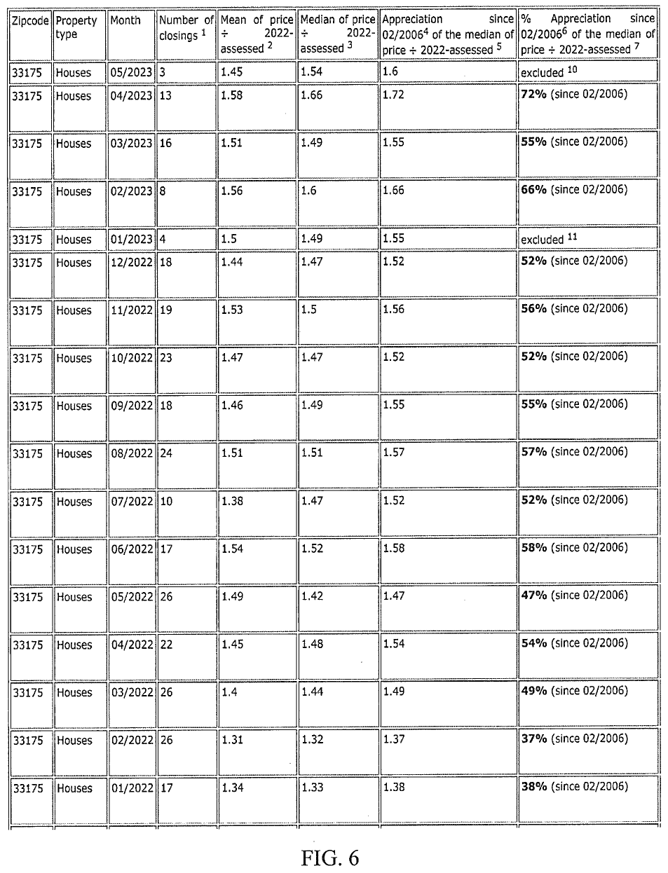

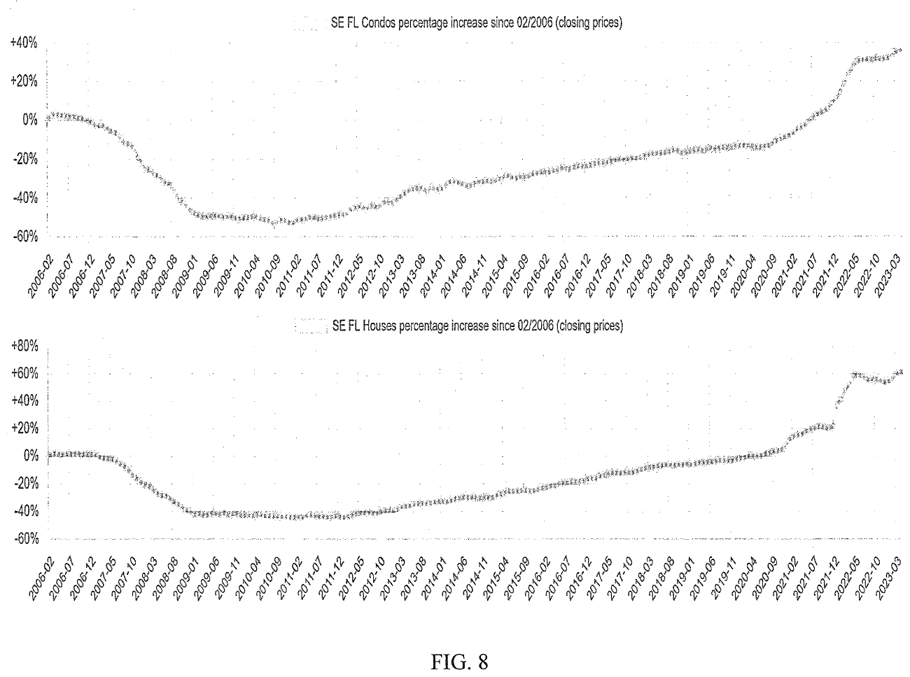

In order to facilitate human comprehension of said average (or median) ratios, they may be normalized to a specific period (e.g., a month) as the base (e.g., the beginning month of said timespan); that is, by computing the factor as the median ratio of any given month divided by the median ratio of the base period. Average (or median) prices can thereby be expressed as the percentage increase (or decrease) since the base month, as in FIGS. 5 and 6. In order for users to better understand the results, said factors can be presented as a graph, as in FIG. 7. FIG. 7 indicates how property values in the locale changed over time. The locale can be of any size, as long as there are enough sale transactions therein to make a statistically significant analysis. The example in FIG. 8 shows the entire southeast Florida (SE FL) region as one locale and differentiates two property categories: condominium units; and single-family homes.

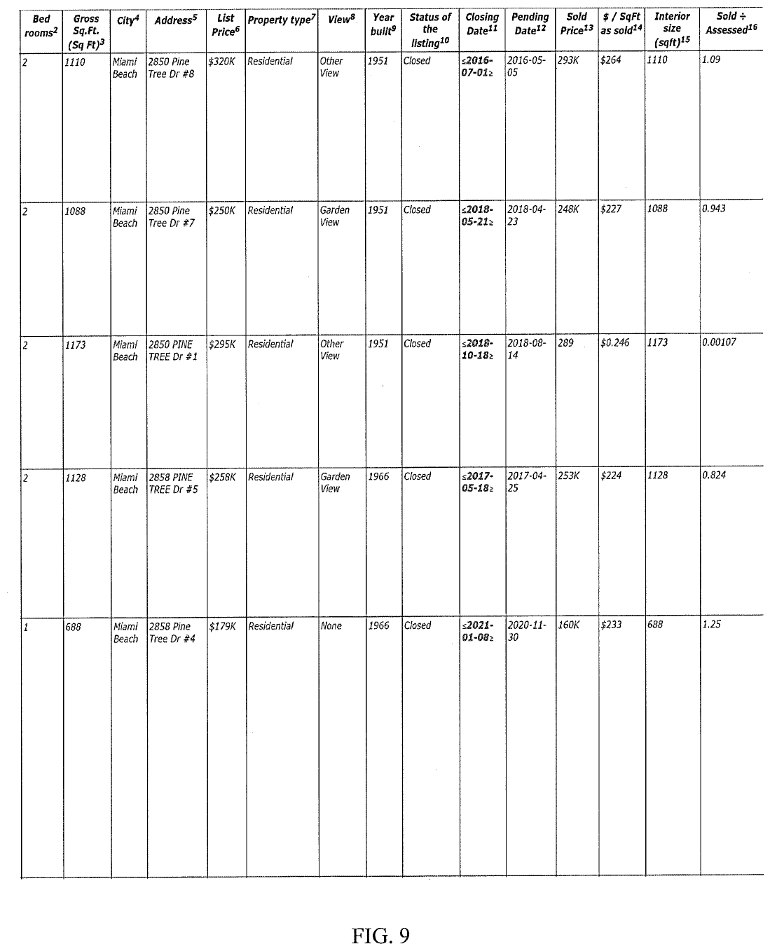

In some embodiments, the contract pending date can be used as an alternative to the closing date. The closing date of property sale transactions have an imperfection in their utility to assess the contemporary market sentiment. This is because the market sentiment is manifested at the time of the execution of a contract for purchase and sale between the buyer and the seller, while the closing of the transaction typically occurs a month or a couple of months later. In order to capture the timeliness of the market sentiment more precisely, transactions that have closed can be considered but dated at the purchase contract's effective date rather than at the closing date. Said purchase contract date can typically be obtained from MLS data sources (where it is often referred to as the “Pending Date”; i.e., the date the property went under a purchase contract and became pending closing), as in FIG. 9.

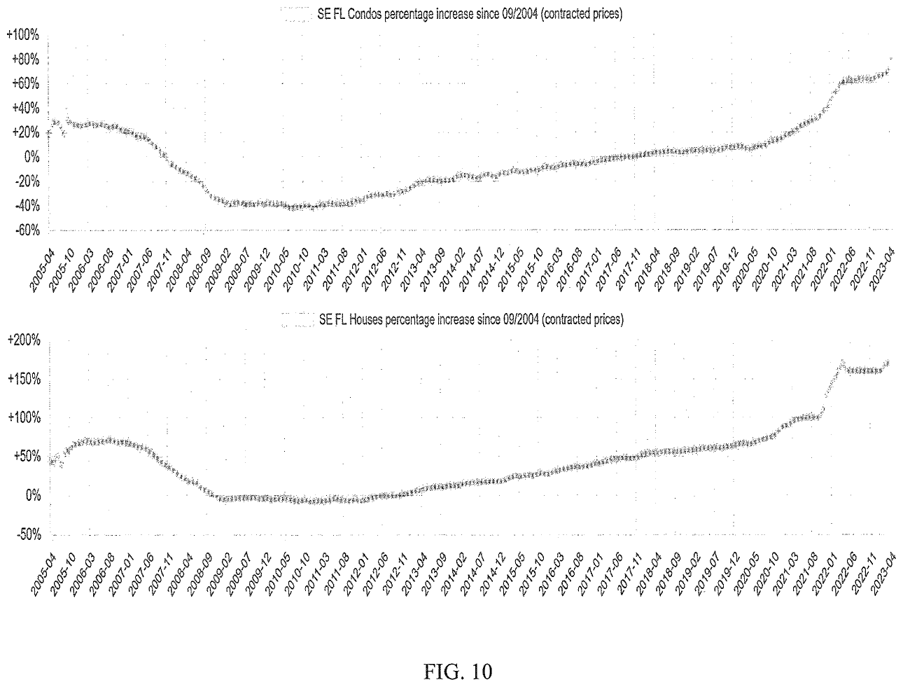

By reanalyzing the same data for sales closed between January 2006 and June 2012, the graphs in FIG. 10 more accurately show the timely market sentiment during most periods, compared to FIG. 8. Although in this embodiment, more accurate market sentiment analysis is present in most periods, there may be noise bias at the edges. The two rightmost data points in the example in FIG. 10 aggregate properties closed by June 2022 but contracted for purchase in May 2022 or June 2022 (because the chosen timespan in this example is user-defined as properties closed from January 2006 to June 2022). Because the time elapsing between the contract date and the closing date in May and June's data is very short, these data points are biased towards cash sales (not contingent on mortgages), which often allow the buyer to negotiate lower prices. This bias can be excluded by disregarding the rightmost edge of the chart. There is also a bias noise at the left edge of the chart because the leftmost points include a few unusual transactions with contract dates as early as April 2005 that were closed in January 2006 or later. This bias can be excluded by disregarding the transactions where the purchase contract date is prior to the beginning of the user-chosen timespan (in this example, January 2006).

Large locales (e.g., states and metropolitan areas) can be partitioned into smaller locales (e.g., townships and zip codes), thus enabling the comparison of a locale to its neighbors as well as to its subsuming locales. A representative statistical aggregator function is a function that matches any set of numbers to a single number intended to be a typical representative of said set. Examples of representative statistical aggregator functions are: median (“pure median”); average (“pure average”); average of the input set's elements excluding the lowest 10% and the highest 10% of said set; 0.5*median+0.5*average; 0.3*median+0.7*(average of the input set's elements excluding the lowest 5% and the highest 9% of said set); and average of the input set's elements, excluding those elements that are outside predefined outlier thresholds of minimum 0.5 and maximum 1.5. Embodiments of the subject invention involve the computation of a representative statistical aggregator function of all the purchase transactions in a given locale during a given period. The easiest such aggregator function to compute is pure average. Among various statistical concerns with the pure average function, it may deliver significantly misleading results if the input data is not pre-cleansed of outliers. The pure median aggregator is more resilient to outliers, yet it still can benefit from the pre-cleansing of outliers. Outliers can be the result of erroneous data entry or the inclusion of esoteric transactions.

From the data cleansing algorithms' point of view, there are several types of outlier cleansing that can be applied to a dataset of said ratios between transactional prices and the fixed-date objective valuation, as listed below.
Fixed threshold: disregard transactions with ratios outside of a given range (e.g., a range of from 0.5 to 3.0).
Percentage threshold: for a given category of properties, locale, and period, disregard certain percentages of the lowest and the highest ratios (e.g., the lowest 10% and the highest 5%).
Statistically insignificant periods: for a given category of properties, locale, and period, if the number of the otherwise qualified transactions in the period is very small (e.g., less than 6), disregard all these transactions; i.e., skip this period for this locale (and for trend presentation purposes, interpolate this period from neighboring periods).
Date-dependent threshold: for transaction dates far removed from the fixed year of the valuation, allow more liberal thresholds than those close to the valuation year. For example, if the objective valuation date is Jan. 1, 2021, then for transactions in year y, where y<2021 (e.g., y=2010), set the minimum threshold to 0.7−0.05*(2021−y).
Semantic outliers that involve analysis of additional data fields, for example: if there is a data field indicating that this is a foreclosure sale, disregard the transaction for being esoteric with the expected price being too low; likewise, for short sales; and if there is a data field showing when the house was built (what in the governmental language is called “year of property improvement”), then disregard the transactions where said improvement date falls in between the transaction date and the fixed objective valuation date (this would prevent or inhibit, for example, the incorrect relating of the sale price of a building to the appraised value of bare land before the building was built).

Embodiments of the subject invention provide a focused technical solution to the focused technical problem of how to objectively evaluate historical trends in real estate prices. Embodiments of the subject invention can improve the device on which the processor is located by minimizing the resources dedicated to calculating any statistical trends because of the efficiency provided by the embodiments.

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

When ranges are used herein, such as for weight ranges, combinations and subcombinations of ranges (e.g., subranges within the disclosed range), specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 foot” means from 0.95 foot to 1.05 foot.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A system for evaluating a historical trend in real estate prices, the system comprising:
a processor; and
a machine-readable medium in operable communication with the processor and having instructions stored thereon that, when executed by the processor, perform the following steps:
receiving first real estate data comprising a geographic locale, a category of real estate properties, and a timespan;
receiving second real estate data comprising price information for each real estate transaction of a plurality of real estate transactions in the geographic locale, in the category of real estate properties, and in the timespan, the second real estate data comprising a sale price for each real estate transaction of the plurality of real estate transactions;
receiving objective valuation data for each property of the plurality of real estate transactions, the objective valuation data comprising an objective valuation at a fixed valuation date for each property of the plurality of real estate transactions, the objective valuation being from a third-party source that was not involved in any real estate transaction of the plurality of real estate transactions;
computing a ratio, for each real estate transaction of the plurality of real estate transactions, of the respective sale price to the respective objective valuation;
partitioning the timespan into a plurality of time periods; and
applying a statistical aggregation function on each time period, comprising applying the statistical aggregation function on all ratios within the respective time period to provide the historical trend of real estate prices relative to the objective valuation data.

2. The system according to claim 1, the geographic locale being a zip code, a neighborhood, a town, a city, a county, a metropolitan area, or a state.

3. The system according to claim 1, the category of real estate properties being single-family dwellings, condominium apartments, multiple-family dwellings, houses of a predetermined size range, commercial real estate, or vacant land.

4. The system according to claim 1, the statistical aggregation function being a median or a mean.

5. The system according to claim 1, each time period of the plurality of time periods being a month, a quarter, or a year.

6. The system according to claim 1, the fixed valuation date for each property of the plurality of real estate transactions being a specific date on which a governmental entity publishes assessment valuations for the geographic locale.

7. The system according to claim 1, the instructions when executed further performing the following step:
removing any outliers from the plurality of real estate transactions before applying the statistical aggregation function,
a real estate transaction being considered an outlier if a characteristic of the real estate transaction is outside a predetermined range compared to the remaining real estate transaction of the plurality of real estate transaction.

8. The system according to claim 1, further comprising a display in operable communication with the processor,
the instructions when executed further performing the following steps:
providing a plot of the historical trend of real estate prices relative to the objective valuation over the timespan; and
displaying the plot on the display.

9. The system according to claim 1, further comprising a display in operable communication with the processor,
the instructions when executed further performing the following steps:
computing a percentage difference of the statistical aggregation function for each time period compared to the statistical aggregation function of all time periods of the timespan;
providing a plot of the percentage difference for each time period over the timespan; and
displaying the plot on the display.

10. The system according to claim 1, the instructions when executed further performing the following steps:
partitioning the geographic locale into a plurality of sub-locales;
applying the statistical aggregation function independently on each sub-locale of the plurality of sub-locales; and
comparing a result of applying the statistical aggregation function for a first sub-locale of the plurality of sub-locales to that of a second sub-locale of the plurality of sub-locales.

11. The system according to claim 1, the third-party source that was not involved in any real estate transaction of the plurality of real estate transactions being a governmental entity.

12. A method for evaluating a historical trend in real estate prices, the method comprising:
receiving first real estate data comprising a geographic locale, a category of real estate properties, and a timespan;
receiving second real estate data comprising price information for each real estate transaction of a plurality of real estate transactions in the geographic locale, in the category of real estate properties, and in the timespan, the second real estate data comprising a sale price for each real estate transaction of the plurality of real estate transactions;
receiving objective valuation data for each property of the plurality of real estate transactions, the objective valuation data comprising an objective valuation at a fixed valuation date for each property of the plurality of real estate transactions, the objective valuation being from a third-party source that was not involved in any real estate transaction of the plurality of real estate transactions;
computing a ratio, for each real estate transaction of the plurality of real estate transactions, of the respective sale price to the respective objective valuation;
partitioning the timespan into a plurality of time periods; and
applying a statistical aggregation function on each time period, comprising applying the statistical aggregation function on all ratios within the respective time period to provide the historical trend of real estate prices relative to the objective valuation data.

13. The method according to claim 12, the geographic locale being a zip code, a neighborhood, a town, a city, a county, a metropolitan area, or a state,
the category of real estate properties being single-family dwellings, condominium apartments, multiple-family dwellings, houses of a predetermined size range, commercial real estate, or vacant land,
each time period of the plurality of time periods being a month, a quarter, or a year, and
the third-party source that was not involved in any real estate transaction of the plurality of real estate transactions being a governmental entity.

14. The method according to claim 12, the statistical aggregation function being a median or a mean.

15. The method according to claim 12, the fixed valuation date for each property of the plurality of real estate transactions being a specific date on which a governmental entity publishes assessment valuations for the geographic locale.

16. The method according to claim 12, further comprising removing any outliers from the plurality of real estate transactions before applying the statistical aggregation function,
a real estate transaction being considered an outlier if a characteristic of the real estate transaction is outside a predetermined range compared to the remaining real estate transaction of the plurality of real estate transaction.

17. The method according to claim 12, further comprising:
providing a plot of the historical trend of real estate prices relative to the objective valuation over the timespan; and
displaying the plot on a display.

18. The method according to claim 12, further comprising:
computing a percentage difference of the statistical aggregation function for each time period compared to the statistical aggregation function of all time periods of the timespan;
providing a plot of the percentage difference for each time period over the timespan; and
displaying the plot on a display.

19. The method according to claim 12, further comprising:
partitioning the geographic locale into a plurality of sub-locales;
applying the statistical aggregation function independently on each sub-locale of the plurality of sub-locales; and
comparing a result of applying the statistical aggregation function for a first sub-locale of the plurality of sub-locales to that of a second sub-locale of the plurality of sub-locales.

20. A system for evaluating a historical trend in real estate prices, the system comprising:
a processor;
a display in operable communication with the processor; and
a machine-readable medium in operable communication with the processor and having instructions stored thereon that, when executed by the processor, perform the following steps:
receiving first real estate data comprising a geographic locale, a category of real estate properties, and a timespan;
receiving second real estate data comprising price information for each real estate transaction of a plurality of real estate transactions in the geographic locale, in the category of real estate properties, and in the timespan, the second real estate data comprising a sale price for each real estate transaction of the plurality of real estate transactions;
receiving objective valuation data for each property of the plurality of real estate transactions, the objective valuation data comprising an objective valuation at a fixed valuation date for each property of the plurality of real estate transactions, the objective valuation being from a third-party source that was not involved in any real estate transaction of the plurality of real estate transactions;
computing a ratio, for each real estate transaction of the plurality of real estate transactions, of the respective sale price to the respective objective valuation;
partitioning the timespan into a plurality of time periods;
applying a statistical aggregation function on each time period, comprising applying the statistical aggregation function on all ratios within the respective time period to provide the historical trend of real estate prices relative to the objective valuation data;
providing a plot of the historical trend of real estate prices relative to the objective valuation over the timespan; and
displaying the plot on the display,
the geographic locale being a zip code, a neighborhood, a town, a city, a county, a metropolitan area, or a state,
the category of real estate properties being single-family dwellings, condominium apartments, multiple-family dwellings, houses of a predetermined size range, commercial real estate, or vacant land,
the statistical aggregation function being a median or a mean,
each time period of the plurality of time periods being a month, a quarter, or a year,
the fixed valuation date for each property of the plurality of real estate transactions being a specific date on which a governmental entity publishes assessment valuations for the geographic locale,
the instructions when executed further performing the following step:
removing any outliers from the plurality of real estate transactions before applying the statistical aggregation function, and
a real estate transaction being considered an outlier if a characteristic of the real estate transaction is outside a predetermined range compared to the remaining real estate transaction of the plurality of real estate transaction.
